(19) United States
(12) Patent Application Publication
(10) Pub. No.: US 2015/0220297 A1
(43) Pub. Date: Aug. 6, 2015

(54) LED Video Display Remote Power Consumption Monitoring and Self-Diagnostic System

(71) Applicant: Mitsubishi Electric Power Products, Inc., Warrendale, PA (US)

(72) Inventor: Michael Anthony Mascari, Allison Park, PA (US)

(73) Assignee: Mitsubishi Electric Power Products, Inc., Warrendale, PA (US)

(21) Appl. No.: 14/173,129

(22) Filed: Feb. 5, 2014

(51) Int. Cl. G06F 3/14; G09G 3/32; G09G 3/20

(52) U.S. Cl. CPC G06F 3/1423; G09G 3/2085; G09G 3/32

(57) ABSTRACT

In a LED display and method of operation thereof, a current drawn by each lighting unit of a number of tiled lighting units, each of which includes a number of LEDs, is determined and compared to one or more predetermined current thresholds related to current(s) expected to be drawn by the lighting unit when operating properly to determine if the lighting unit is experiencing a failure. If the lighting unit is determined to be experiencing a failure, a network address of the lighting unit can be used to identify the physical location of the lighting unit in the LED display and/or the lighting unit is controlled to display differently (or not at all) than other lighting unit(s) not experiencing a failure or experiencing a difficult failure as an aid in locating the lighting unit experiencing the failure.

### BACKGROUND OF THE INVENTION

1. Field of the Invention

The present invention relates to large scale LED video displays that are utilized, for example, in large sports arenas or stadiums, such as football stadiums and basketball arenas, and more particularly, to an apparatus and method for determining when a lighting unit of such large scale LED video displays is experiencing a failure and to cause said lighting unit to display in a manner different than other lighting units of the display to facilitate identification and repair or replacement of the lighting unit exhibiting the failure.

2. Description of Related Art

Large scale LED video displays utilized, for example, in large sports arenas or stadiums, are comprised of a plurality of smaller unitized printed circuit board (PCB) assemblies called lighting units (LU). LEDs are mounted to the front face of each LU PCB so light can be emitted and viewed. Outdoor LUs are encased in potting compound or other waterproofing means to protect sensitive electronics. LUs can vary in size according to various product lines with an exemplary viewing area of approximately 0.1 square meters. Each LU can include a large number of pixels, e.g., without limitation 1,024 pixels, with each pixel comprised of one or more LEDs, e.g., without limitation a red, green, and blue LED. One example of such large scale LED video display is manufactured under the trademark “Diamond Vision®” which is a registered trademark in the U.S. of Mitsubishi Electric Corporation, U.S. Registration No. 1,283,083.

Modern large scale LED video displays are comprised of tens or hundreds of LUs, totaling tens to hundreds of square meters of areas, and thousands or millions of discrete LEDs. Accordingly, visual inspection for LED failures with the human eye is tedious and may not detect all faults.

Moreover, many large scale LED video displays are utilized in systems with marketing contracts valued at thousands of dollars per hour. However, it is not cost effective to individually monitor each LED and cooling fan of such large scale LED video displays individually. In such a system, autonomous fault detection and preventive maintenance feedback data is extremely desirable, but is presently not available.

### SUMMARY OF THE INVENTION

The present invention measures, desirably in real-time, DC power consumption at the lighting unit (LU) level. A current sensor, such as a hall effect IC sensor or a shunt resistor can be employed for high-speed power measurement. The analog data available from such current sensor can be processed and converted into digital form and transmitted using an existing channel for further processing. An analog-to-digital converter can be used for converting analog data into digital form. The transmitted data can be utilized to provide operational status feedback and formatting by an operation terminal for automated and/or human interpretation at the operation terminal.

The power consumption data for each LU can be utilized to provide detection of LU display status such as, normal run status; entire LU display failure; discrete or small LED groups false negative (non-display/always off), and discrete or small LED groups false positive (stuck displays/always on).

The present invention also enables detection of LU cooling fan operation in three modes, namely: normal; open fan failure, i.e., no current draw by the fan; and a locked rotor failure, i.e., above-normal current draw by the fan.

Benefits of the present invention include: near instantaneous power reduction adjustments at the individual LU level rather than only at the entire screen level; reduced likelihood of LU over-temperature condition leading to entire screen dimming by localized LU dimming during local overload conditions; extend life of LUs by reducing power consumption during high stress events such as localized 100 percent brightness white content; and reduce amount of over-specification required for individual power supplies by ensuring that LU power draw does not exceed manufacturer's power supply rating after any applicable derating is applied. It is believed that this latter benefit will result in thousands of dollars of savings per large scale LED video display by enabling selection of lower rated power supplies for use with the LUs of such large scale LED video display. Additional benefits include: extend life of reduced rating switch-mode power supplies and other power transmittal and transformation equipment by avoiding temporary over current conditions.

The present invention also enables remote reporting of power consumption of the entire display or any specified fraction thereof, desirably in real-time. Combined with local kilowatt hour (KWH) rates, this enables the financial costs of brightness adjustments and extended run times to be determined. Lastly, the present invention provides fault location identify information to aid in expedited troubleshooting. Reporting of faults can be color-coded and displayed on the screen for visual identification and location. For example, normal locations could be displayed in one color and/or pattern, while fault locations could be coded in another color and/or display pattern.

More specifically, the invention is a method of operating a LED display comprised of a plurality of unitized lighting units tiled together, wherein each lighting unit includes a plurality of LEDs. The method includes: (a) for each lighting unit, determining via a computer network a current drawn by said lighting unit in response to a control signal received by said lighting unit via the computer network; (b) based on the current determined in step (a), determining that said lighting unit is experiencing a failure mode; and (c) determining a physical location of said lighting unit in the LED display via a network address of said lighting unit, by controlling illumination of a subset of the LEDs of said lighting unit, or both.

As used herein “subset” has its common dictionary definition, namely, a set consisting of elements of a given set that can be the same as the given set or smaller (see definition of “subset” at http://www.thefreedictionary.com/subset; “Math. a set consisting of elements of a given set that can be the same as the given set or smaller”). For example, in a lighting unit that includes 1024 pixels, with each pixel including 3 LEDs, whereupon the lighting unit has a total of 3072 LEDs, a subset of these 3072 LEDs can include all 3072 LEDs or some number of LEDs less than 3072 LEDs.

The method can include the control signal being a request for said subset of the LEDs of said lighting unit to illuminate and step (b) can include determining that the failure mode is the current drawn by said lighting unit in response to the control signal is less than a predetermined current threshold indicative of said subset of the LEDs of said lighting unit illuminating.

The method can include the control signal being a request for said subset of the LEDs of said lighting unit to illuminate and step (b) can include determining that the failure mode is the current drawn by said lighting unit in response to the control signal being less than a predetermined lower current threshold indicative of said subset of the LEDs of said lighting unit not illuminating a greater than a predetermined upper current threshold indicative of said subset of the LEDs of said lighting unit illuminating.

The method can include the control signal being a request for said subset of the LEDs of said lighting unit to not illuminate and step (b) can include determining that the failure mode is the current drawn by said lighting unit in response to the control signal being greater than a predetermined current threshold indicative of said subset of the LEDs of said lighting unit not illuminating.

In step (c), controlling illumination of the subset of the LEDs of said lighting unit can include displaying one or more colors or patterns different than a subset of the LEDs of at least one other lighting unit of the LED display that is not experiencing a failure mode or is experiencing a different failure mode.

The failure mode can include: determining that said subset of the LEDs of said lighting unit are not illuminating when the control signal is requesting that they be illuminating; or determining that said subset of the LEDs of said lighting unit are illuminating when the control signal is requesting that they not be illuminating.

Step (c) can include increasing, maintaining, reducing, terminating, or some combination thereof, the electrical power applied to said subset of the LEDs of said lighting unit.

The LED display can include at least one cooling fan and the method can further include: (d) determining current drawn by said cooling fan; (e) based on the current determined in step (d), determining that said cooling fan is experiencing a failure; and (f) following step (e), terminating the supply of electrical power to said cooling fan.

Step (e) can include the fan either drawing current indicative of a locked rotor condition or the fan drawing no current.

Each lighting unit can also include a cooling fan. Step (b) can include determining that the failure mode is the current drawn by said fan being outside of a predetermined normal operating range in response to the control signal requesting said subset of the LEDs of said lighting unit to illuminate or to not illuminate.

The invention is also a method of operating a LED display comprised of a cooling fan and a plurality of unitized lighting units tiled together, wherein each lighting unit includes an array of LEDs. The method includes: (a) determining via a computer network an electrical current drawn by said cooling fan; (b) based on the electrical current determined in step (a), determining that said cooling fan is experiencing a failure; and (c), following step (b), terminating the supply of electrical power to said cooling fan.

The failure in step (b) can be the cooling fan drawing electrical current at a level indicative of either the cooling fan having a locked rotor and drawing electrical current in excess of electrical current drawn when the rotor is rotating, or the cooling fan being an open circuit and drawing no electrical current.

The method can further include: (d) determining via the computer network an electrical current drawn by each lighting unit in response to a control signal output for said lighting unit via the computer network; (e) based on the electrical current determined in step (d), determining that at least one lighting unit is experiencing a failure; and (f) determining a physical location of said lighting unit determined in step (e) via a network address of said lighting unit, by controlling illumination of a subset of the LEDs of said lighting unit, or both.

Each lighting unit can include a lighting unit cooling fan.

The control signal can be a request for said subset of the LEDs of said lighting unit to illuminate; and step (e) can include determining based on the electrical current drawn by said lighting unit being below a current level indicative of said subset of the LEDs of said lighting unit illuminating that at least a portion of said subset of the LEDs of said lighting unit are not illuminated.

The control signal can be a request for said subset of the LEDs of said lighting unit to not illuminate; and step (e) can include determining based on the electrical current drawn by said lighting unit being above a current level indicative of said subset of the LEDs of said lighting unit not illuminating that at least a portion of said subset of the LEDs of said lighting unit are illuminated.

In step (f), the controlling of the illumination of the subset of the LEDs of said lighting unit can include controlling said subset of the LEDs of said lighting unit to display a color or pattern different than a subset of the LEDs of at least one other lighting unit that is not experiencing a failure or is experiencing a different type of failure.

Step (f) can include increasing, maintaining, reducing, terminating, or some combination thereof, the electrical power to said subset of the LEDs of said lighting unit.

Lastly, the invention is a LED display comprising: a plurality of unitized lighting units tiled together, wherein each lighting unit includes a plurality of LEDs, a lighting unit logic circuit operative for controlling the operation of the plurality of LEDs based on signals received by the lighting unit logic circuit, and a current sensing block operative for sensing electrical current supplied to the lighting unit logic circuit and the plurality of LEDs; a lighting unit power supply operative for supplying the electrical current; and a lighting unit controller operative for providing the signals to the lighting unit logic circuit, for acquiring an output of the current sensing block, and for outputting the acquired output of the current sensing block.

The current sensing block can include: a current transducer for sensing the current and for outputting an analog signal based on the sensed current; and an analog-to-digital converter operative for converting the analog signal into a digital signal that is output by the current sensing block.

The current transducer can be either a hall effect sensor or a shunt resistor.

The LED display can be in communication with an operation terminal that is operative for causing the lighting unit controller to supply the signals to the lighting unit logic circuit, for causing the lighting unit controller to acquire the output of the current sensing block, and for processing the output of the current sensing block.

Each lighting unit can further include a fan, and the current sensing block can be operative for sensing electrical current supplied to the combination of the fan, the lighting unit logic circuit, and the plurality of LEDs.

### BRIEF DESCRIPTION OF THE DRAWINGS

FIGS. 1A-1C are front, top, and back views of an exemplary large scale LED display that includes a 10×7 array of lighting units in accordance with the present invention;

FIG. 2 is an exemplary block diagram of eight of the lighting units of the large scale LED display shown in FIG. 1 including lighting unit power supplies that provide power to said lighting units, fans, a fan power supply and a lighting unit controller which, under the control of an operation terminal (also shown), controls the operation of the LEDs of each of the lighting units;

FIG. 3 is an isolated view of a single lighting unit shown in FIG. 2 including a lighting unit logic circuit that includes a current transducer and an analog-to-digital converter;

FIGS. 4A and 4B are a flow diagram of a method of sampling current from each lighting unit of the large scale LED display shown in FIG. 1 and for determining if a lighting unit is exhibiting a failure mode; and

FIG. 5 is an isolated schematic drawing of a fan in FIG. 2 including a current sensing block like the current sensing block of the lighting unit shown in FIG. 3.

### DETAILED DESCRIPTION OF THE INVENTION

The present invention will be described with reference to the accompanying figures where like reference numbers correspond to like or similar elements.

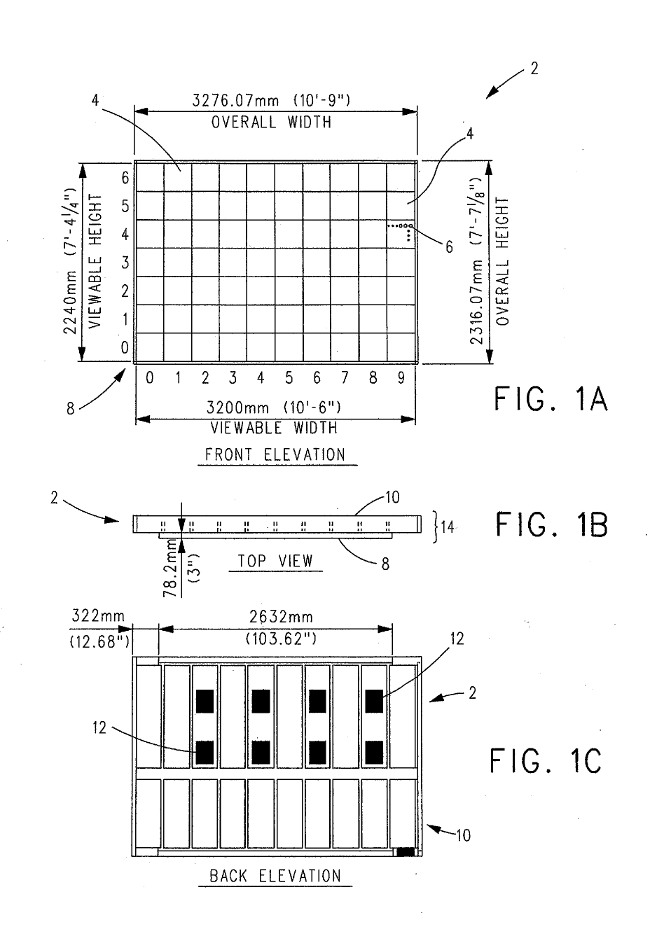

With reference to FIGS. 1A-1C a large scale LED display 2 includes a plurality of smaller, unitized tiled lighting units (LU) 4 tiled together. The embodiment of large scale LED display 2 shown in FIGS. 1A-1C includes a 10×7 array of tiled LUs 4. However, this array size is not to be construed as limiting the invention as it is envisioned that large scale LED display 2 can comprise any suitable and/or desirable X×Y array of LUs 4.

The embodiment large scale LED display 2 shown in FIGS. 1A-1C includes a viewable width of 3,200 millimeters and a viewable height of 2,240 millimeters, with each LU 4 having a width of 320 millimeters and a height of 320 millimeters. However, these dimensions are exemplary and are not to be construed as limiting the invention since it is envisioned that large scale LED display 2 can have any suitable and/or desirable viewable width and/or viewable height. Similarly, each LU 4 of large scale LED display 2 can have any suitable and/or desirable viewable width and height.

In one exemplary non-limiting embodiment, each LU 4 includes an array of 1,024 pixels 6, with each pixel 6 comprised of a red, green, and blue LED. However, each LU 4 can include any suitable and/or desirable number of pixels 6, with each pixel 6 comprising one, two, three, or more LEDs as deemed suitable and/or desirable. Three exemplary pixels 6 are shown in LU 4 at tile position (9, 4) of the large scale LED display 2 of FIG. 1A for the purpose of illustration. It is to be understood, however, that each LU 4 in FIG. 1A has an X×Y array of pixels.

While a front side 8 of large scale LED display 2 includes the array of LUs 4 arranged to output light in the direction normal to said front side 8, a back side 10 of large scale LED display 2 includes one or more fans 12 that is/are operative during use of large scale LED display 2 for maintaining a flow of cooling air in the interior of a frame 14 that supports LUs 4, the fans 12 and related equipment (discussed hereinafter) in the manner shown. The physical arrangement of frame 14 supporting LUs 4 and fans 12 shown in FIGS. 1A-1C is known in the art.

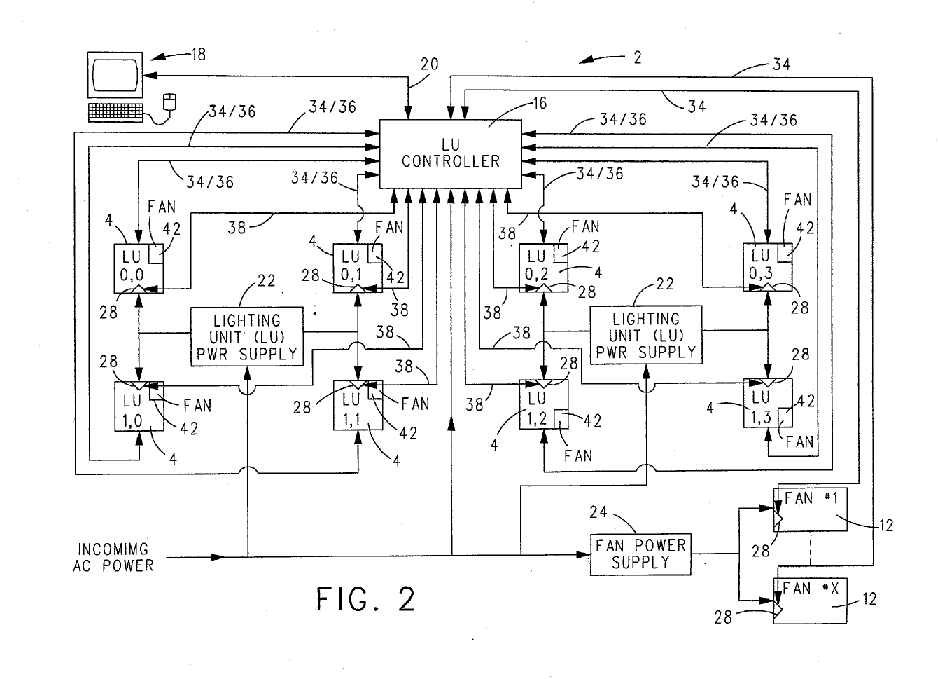

FIG. 2 shows eight LUs 4 of the large scale LED display 2 shown in FIG. 1. More specifically, FIG. 2 shows the LUs 4 at the (X,Y) tile locations (0,0), (0,1), (0,2), (0,3), (1,0), (1,1), (1,2), and (1,3) of large scale LED display 2 in FIG. 1A. Each LU 4 of large scale LED display 2 is connected to an LU controller 16 of large scale LED display 2. In FIG. 2, a single LU controller 16 is shown connected to eight LUs 4 for the purposes of simplicity. However, this is not to be construed as limiting the invention since it is envisioned that each LU 4 of large scale LED display 2 can be connected to the same on a different one of a plurality of LU controllers 16.

LU controller 16 is connected to an operation terminal 18 via a communication link 20. The combination of the LUs 4 of LED display 2, LU controller 16, operation terminal 18 and communication link 20 define a computer network, wherein each LU 4 has a unique network address that is addressable by operation terminal 18 via LU controller 16 and communication link 20. Desirably, the physical location of LUs 4 of LED display 2 and the network addresses associated with the LUs 4 are mapped to facilitate locating the physical location of each LU 4 based upon its network address.

Operation terminal 18 may be based on any suitable and/or desirable computer that includes hardware elements and software elements. These hardware elements may include a microprocessor, volatile and non-volatile memory (such as RAM and ROM), input/output circuitry, a power supply, and a display (touchscreen or conventional) and, optionally, a keyboard, and/or a mouse. The software elements can include a control program operating under the control of an operating system. The combination of the hardware and software elements enables operation terminal 18 to provide to LU controller 16 a stream of image data that LU controller 16 processes and, based on the network addresses of the LUs 4, distributes to the LUs 4 of large scale LED display 2, based on the network addresses of the LUs 4, in a manner known in the art to cause the LEDs of the LUs 4 to produce one or a series of visually perceptive images. The operation of operation terminal 18, LU controller 16, and the plurality of LUs 4 of large scale LED display 2 in this regard is known in the art.

Communication link 20 can take any suitable and/or desirable form, including a wired link, a wireless link, a fiber optic link, or some combination thereof. Communication link 20 can be operative for enabling two-way communication between LU controller 16 and operation terminal 18. Communication link may also include one or more modems (not shown) that facilitate communication between operation terminal 18 and LU controller 16.

Each LU 4 receives electrical power for its operation from a lighting unit (LU) power supply 22 which converts incoming AC power into DC power at a voltage between, for example, 3-6 volts for use by one or more LUs 4. Each LU power supply 22 can provide DC electrical power to one or two or more LUs 4 as determined by its power supplying capacity and the power requirements of each LU 4 connected to LU power supply 22. The operation of each LU power supply 22 supplying electrical power to the pixels 6 of each LU 4 connected thereto and operating under the combined control of LU controller 16 and a software element running on operation terminal 18 is known in the art.

Optionally, each LU 4 can include an LU fan 42 which is operative during use of large scale LED display 2 for maintaining a flow of cooling air across the pixels of the LU 4 and/or the other elements (described hereinafter) that comprise LU 4.

Large scale LED display 2 also includes one or more fan power supplies 24 for supplying DC electrical power to one or more fans 12. Each fan power supply 24 converts incoming AC power into DC electrical power in an appropriate voltage level for use by each fan 12.

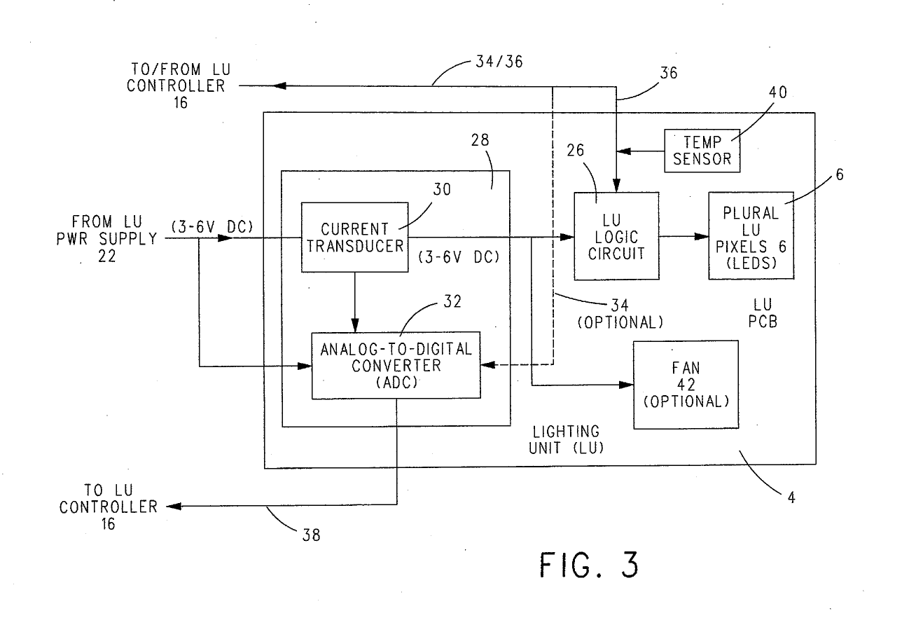

With reference to FIG. 3 and with continuing reference to FIGS. 1A-2, each LU 4 includes a plurality of pixels 6 which are coupled to receive electrical power from a lighting unit (LU) logic circuit 26 which, operating in response to data and control signals from LU controller 16, selectively delivers DC electrical power to the LEDs of the pixels 6 of LU 4 in a manner known in the art. DC electrical power is provided to LU logic circuit 26 and optional LU fan 42 from a LU power supply 22 (FIG. 2) via a current sensing block 28 of LU 4 shown in FIG. 3. Current sensing block 28 includes a current transducer 30 for sensing the current being supplied to or drawn by LU logic circuit 28, pixels 6, and optional fan 42 of LU 4, and an analog-to-digital converter (ADC) 32 for converting the output of current transducer 30 from analog form to digital form which can be provided to an input of LU controller 16 for passage via communication link 20 to operation terminal 18 for processing in a manner to be described hereinafter.

Current transducer 30 can be any suitable and/or desirable form of current transducer that samples or senses DC current flowing to LU logic circuit 26 and pixels 6 of LU 4 and converts the sampled or sensed current into a form, e.g., a voltage, that can be sampled by ADC 32. Non-limiting examples of suitable current transducers 30 include a DC shunt resistor and a hall-effect current transducer. However, this is not to be construed as limiting the invention since it is envisioned that any suitable and/or desirable type or form of current sensing circuit and AC-to-DC converting circuit, now known or hereinafter invented, that is capable of providing to operation terminal 18 via LU controller 16 an indication of the current being supplied to or drawn by LU logic circuit 26 and pixels 6 of LU 4, can be utilized.

ADC 32 operates in a manner known in the art to occasionally or periodically convert the output of current transducer 30 from an analog form to a corresponding digital form which is provided to operation terminal 18 via LU controller 16 and communication link 20.

LU controller 16 is configured to operate under the control of operation terminal 18 to provide the output of each ADC 32 to operation terminal 18. In this regard, LU controller 16 can be configured to either act as a buffer for the digital data output by each ADC 32 or to enable operation terminal 18 to retrieve the output of each ADC 32 at appropriate times. The operation of each ADC 32 to convert the analog output of the current transducer 30 connected thereto into a corresponding digital output can be autonomous or can be controlled by a control signal from LU controller 16, shown by optional dashed line 34 in FIG. 3.

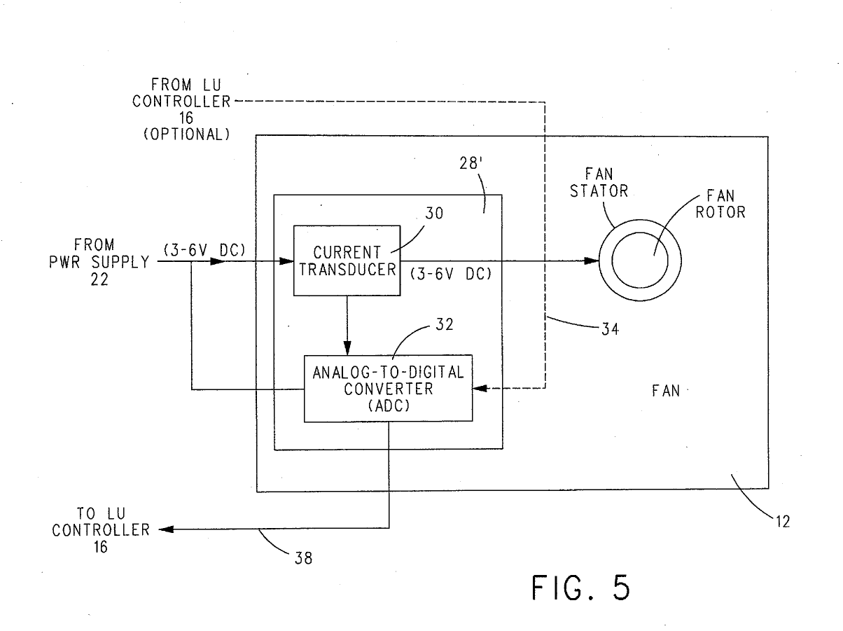

Also or alternatively, as shown in FIG. 5, each fan 12 can include a current sensing block 28 that operates in the manner described above for current sensing block 28 of LU 4 in FIG. 3 for providing an indication of the current drawn by said fan 12 to operation terminal 18 via LU controller 16. As shown in FIG. 2, each fan 12 receives DC electrical power from a fan power supply 24 which converts incoming AC power into the DC electrical power supplied to each fan 12.

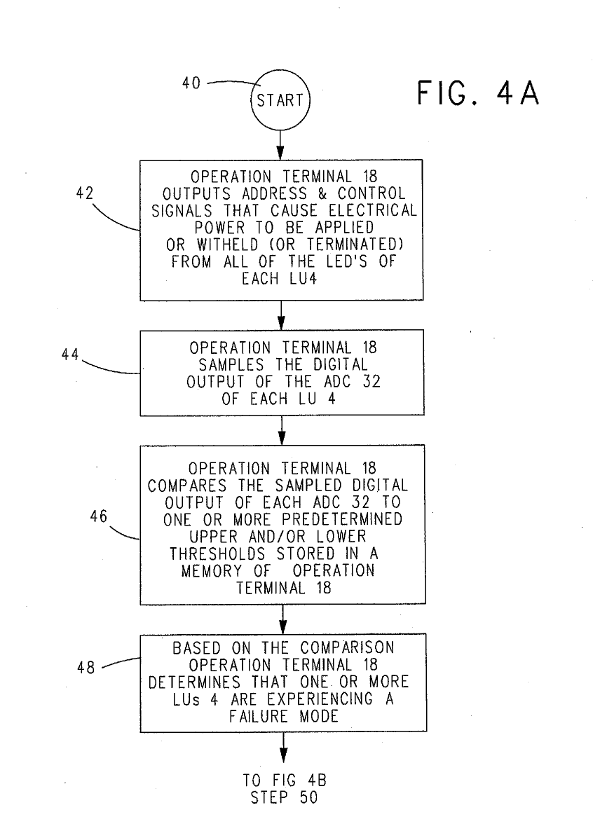

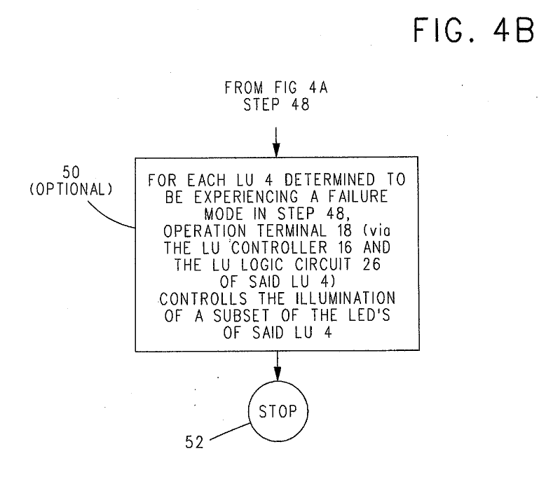

A generalized method of using one instance of a current sensing block 28 to detect whether the corresponding LU 4 is experiencing a failure mode will now be described with reference to the flow diagram of FIGS. 4A and 4B and with continuing reference to FIGS. 1-3.

Initially, the method advances from step 40 and to step 42 where operation terminal 18 outputs one or more address and/or control signals that cause electrical power to be applied or withheld (or terminated) from a subset of the LEDs of each LU 4, either one LED at-a-time or in groups of LEDs 4. Desirably, the combination of LU controller 16 and each LU 4 defines a LU 4 computer network, wherein each LU 4 has a unique network address. The unique network address of each LU 4 enables appropriate control signals to be applied to said LU 4 in a manner known in the art. In addition, the unique network address of each LU 4 sampling of the ADC 32 of said LU 4 by LU controller, either directly or under the control of operation terminal 18. Hence, the unique network address of each LU 4 enables appropriate control signals to be provided to LU 4 and the output of the ADC 32 of said LU 4 to be sampled. Operation terminal 18 and/or LU controller 16 can be configured in any suitable and/or desirable manner to facilitate each LU 4 receiving appropriate control signals, and the sampling of each ADC 32. Hence, the description herein of the operation of operation terminal 18 and/or LU controller is not to be construed as limiting the invention.

In step 44, operation terminal 18 samples the output of the ADC 32 of each LU 4. In step 46, operation terminal 18 compares the sampled digital output of each LU 4 ADC 32 (which digital output corresponding to the current being drawing by said LU 4) to one or more predetermined upper and/or lower thresholds stored in a memory of operation terminal 18. In step 48, operation terminal 18, based on the comparison in step 46, determines that one or more LUs 4 are experiencing a failure mode. Because there is a one-to-one correspondence between each LU 4 and the network address for said LU 4, the network address for each LU 4 experiencing a failure mode can be utilized to determine the physical location of said LU 4 experiencing a failure mode, e.g., via a mapping between the physical location of each LU 4 of LED display 2 and the network addresses of said LUs 4. Lastly, in an optional step 50, for each LU 4 determined to be experiencing a failure mode in step 48, operation terminal 18 can control the illumination of a subset of the LEDs of said LU 4.

In the embodiment shown in FIG. 2, communication between operation terminal 18 and each LU 4 passes through LU controller 16 which converts higher level command, control, and data signals from operations terminal 18 into lower level signals supplied to the LU logic circuit 28 of each LU 4 and which receives digital signals output by each ADC 32. Each ADC 32 can periodically or occasionally sample the output of its corresponding current transducer 30, either under the control operation terminal 18 via LU controller 16 or via internal control circuitry (not shown) of ADC 32. The particular manner in which each ADC 32 is operative for sampling the output of the corresponding current transducer 30 is not be construed as limiting the invention.

In optional step 50, the controlling of the illumination of the subset of the LEDs of said LU 4 can include increasing, maintaining, reducing, terminating, or some combination thereof, the electrical power applied to said subset of the LEDs of said LU 4. Also or alternatively, controlling the illumination of said subset of the LEDs of said LU 4 can include controlling said subset of the LEDs to display one or more colors and/or patterns different than a subset of the LEDs of at least one other lighting unit of the LED display that is not experiencing a failure mode or is experiencing a different failure mode.

For example, and without limitation, by selectively controlling (1) the power provided to a subset of the LEDs of an LU 4 experiencing a failure mode and (2) the power provided to a subset of the LEDs of an LU 4 not experiencing a failure, the subset of LEDs of an LU 4 experiencing a failure can be made to illuminate more brightly or less brightly (including no illumination) than the subset of LEDs of an LU 4 not experiencing a failure mode thereby enabling the LU 4 experiencing the failure mode to be readily identified.

Also or alternatively, when each pixel 6 of an LU 4 comprises different colored LEDs, e.g., without limitation, red, green, and blue LEDs, an LU 4 experiencing a failure mode can be made to display one color (red, green, blue or some combination thereof) while the LEDs of one or more LU 4 not experiencing a failure mode can be made to display another color, whereupon the LU 4 experiencing a failure mode can be readily identified. Also or alternatively, the LEDs of an LU 4 experiencing a failure mode can be controlled to display a pattern different than LEDs of each LU 4 not experiencing a failure mode.

Thus, as can be seen, each LU 4 experiencing a failure mode can be operated in a manner different than one or more LU 4s not experiencing failure mode to facilitate visual identification of the LU 4 experiencing the failure mode. This difference in operation can include one or more of the following: different levels of illumination (brighter, dimmer, or off); different patterns of illuminated LEDs; different color LEDs being illuminated; and/or some combination of the foregoing.

A more detailed, non-limiting example of operating the large scale LED display 2 shown in FIG. 1 will now be described. This description will assume that optional LU fan 42 of each LU 4 is not present.

For each LU 4, a current drawn by said LU 4 is determined by sampling the ADC 32 of said LU 4 in response to operation terminal 18 outputting address and control signals. The address signal is utilized by LU controller 16 to direct the control signals to said LU 4. The control signals can include a request for a subset (all or less than all) of the LEDs of said LU 4 to illuminate. Based on the current determined to be drawn by said LU 4 from the sampled output of the ADC 32 of said LU 4, a determination is then made by operation terminal 18 whether said LU 4 is experiencing a failure mode. This failure mode may be the current being drawn by said LU 4 in response to the control signal being greater than or equal to a predetermined upper current threshold indicative of said subset of LEDs of said LU 4 illuminating.

Also or alternatively, the failure mode can be the current drawn by said LU 4 in response to the control signal being less than a predetermined lower current threshold indicative of said subset of LEDs of said LU 4 not illuminating and a greater than predetermined upper current threshold indicative of said subset of LEDs of said LU 4 illuminating. As used herein, the word “subset” means a set consisting of elements of a given set that can be the same as the given set or smaller.

The failure mode can, also or alternatively, be the current drawn by said LU 4 in response to the control signal being greater than or equal to a predetermined lower current threshold indicative of said subset of LEDs not illuminating.

Assuming that each LU 4 includes optional LU fan 42, the current drawn by said fan 42 in normal operation, in a locked rotor condition, or in an open rotor condition would be sampled by the ADC 32 of said LU 4 when sampling the current determined to be drawn by the LEDs 6, LU logic circuit 26 and/or ADC 32 of said LU 4. Different upper and/or lower current thresholds may be utilized to determine when an LU 4 has experienced a failure mode based on a subset of LEDs of said LU 4 illuminating or not illuminating when the fan 42 of said LU 4 is running within rated tolerance levels and/or not running, e.g., due to a locked rotor condition or the rotor of fan 42 being an open circuit. For example, if the LEDs of said LU 4 are commanded to not illuminate, LU fan 42 of said LU 4 would be expected to draw current within a predetermined range. A current above this predetermined range may indicate that certain LEDs of said LU 4 are illuminating when they should not be illuminating or that said fan 42 is drawing excessive current indicative of excessive rotor friction, e.g., without limitation a locked rotor condition. In other words, where an LU 4 includes an optional LU fan 42, the current expected to be drawn by said fan 42 can be considered when analyzing whether said LU 4 is experiencing a failure mode.

Next, based on operation terminal 18 determining that the LU 4 is experiencing a failure mode, the illumination of a subset of LEDs of the LU 4 can be controlled. This control can include increasing, maintaining, reducing, terminating, or some combination thereof, the electrical power applied to said subset of LEDs of said LU 4. Also or alternatively, this control can include controlling said subset of LEDs of said LU 4 to display one or more colors different than a subset of LEDs of at least one other LU 4 of the large scale LED display 2 that is not experiencing a failure mode or that is experiencing a different failure mode. Also or alternatively, this control can include controlling said subset of LEDs of said LU 4 to display a different pattern than a subset of LEDs of at least one other LU 4 of the large scale LED display 2 that is not experiencing a failure mode or that is experiencing a different failure mode.

With reference to FIG. 5, each fan 12 can also or alternatively include its own current sensing block 28 that includes a current transducer 30 for sensing the current supplied to the fan rotor and an ADC 32 for converting the analog output of current transducer 30 into a digital output for sampling via LU controller 16 and communication link 20, and processing by operation terminal 18 in a manner similar to the current sensing block 28 of each LU 4 described above. By way of the current sensing block 28 associated with each cooling fan 12, it can be determined whether said cooling fan 12 is experiencing a failure or not. Specifically, operation terminal 18 can periodically or occasionally sample the digital output of the ADC 32 of the current sensing block 28 of each cooling fan 12, which digital output corresponds to the current being supplied to the rotor of cooling fan 12. Next, based on the current determined by operation terminal 18 to be drawn by said cooling fan 12, operation terminal 18 determines whether said cooling fan is experiencing a failure or not. A failure may be the cooling fan 12 drawing a current indicative of a locked rotor condition where the cooling fan 12 draws electrical current in excess of an upper predetermined current threshold indicative of the rotor rotating, or cooling fan 12 drawing a current below a lower predetermined current threshold (e.g., no current) indicative of the rotor of cooling fan 12 being an open circuit.

In the foregoing description, the process of operation terminal 18 determining whether one or more LU 4s are experiencing a failure mode or whether one or more cooling fans 12 are experiencing a failure can be accomplished in any order.

FIG. 2 shows multiple instances of LU 4, current sensing block 28, fan 12, line 34/36 and line 38 and LU power supply 22, with like elements being represented by the same reference number for simplicity. It is to be appreciated, however, that each instance of each like numbered elements in FIG. 2 is unique. Furthermore, FIG. 3 illustrates of one instance of LU 4 including a corresponding current sensing block 28 and related lines 34/36 and 38 in FIG. 2. In FIGS. 2 and 3, each instance where of line 36 and optional line 34 are combined is for the purpose of simplicity of illustration.

Benefits of the system and method described above include timely detection of faults (e.g., in substantially real-time) to prevent damage to LEDs, LUs 4, and fans 12; determining that a LU 4 has failed partially or entirely; determining that a subset of the LEDs of a particular LU 4 are experiencing a failure (always off or always on); timely reporting power consumption remotely; provide protection of LUs from above specification power drain which may cause damage; extend the life of LU power supplies 22, which are desirably switch-mode power supplies; and determine cooling fan 12 and/or 42 status (normal, open failure, or locked rotor failure).

The present invention has been described with reference to preferred embodiments. Obvious modifications and alterations will occur to those of ordinary skill in the art upon reading and understanding the preceding detailed description. It is intended that the invention be construed as including all such modifications and alterations insofar as they come within the scope of the appended claims or the equivalents thereof.

The invention claimed is:

1. A method of operating a LED display comprised of a plurality of unitized lighting units tiled together, wherein each lighting unit includes a plurality of LEDs, said method comprising:
(a) for each lighting unit, determining via a computer network a current drawn by said lighting unit in response to a control signal received by said lighting unit via the computer network;
(b) based on the current determined in step (a), determining that said lighting unit is experiencing a failure mode; and
(c) determining a physical location of said lighting unit in the LED display via a network address of said lighting unit, by controlling illumination of a subset of the LEDs of said lighting unit, or both.

2. The method of claim 1, wherein:
the control signal is a request for said subset of the LEDs of said lighting unit to illuminate; and
step (b) includes determining that the failure mode is the current drawn by said lighting unit in response to the control signal is less than a predetermined current threshold indicative of said subset of the LEDs of said lighting unit illuminating.

3. The method of claim 1, wherein:
the control signal is a request for said subset of the LEDs of said lighting unit to illuminate; and
step (b) includes determining that the failure mode is the current drawn by said lighting unit in response to the control signal being less than outside of a predetermined lower current threshold indicative of said subset of the LEDs of said lighting unit not illuminating or greater than a predetermined upper current threshold indicative of said subset of the LEDs of said lighting unit illuminating.

4. The method of claim 1, wherein:
the control signal is a request for said subset of the LEDs of said lighting unit to not illuminate; and
step (b) includes determining that the failure mode is the current drawn by said lighting unit in response to the control signal being greater than a predetermined current; threshold indicative of said subset of the LEDs of said lighting unit not illuminating.

5. The method of claim 1, wherein step (c) includes controlling said subset of the LEDs of said lighting unit to display one or more colors or patterns different than a subset of the LEDs of at least one other lighting unit of the LED display that is not experiencing a failure mode or is experiencing a different failure mode.

6. The method of claim 1, wherein the failure mode includes:
determining that said subset of the LEDs of said lighting unit are not illuminating when the control signal is requesting that they be illuminating; or
determining that said subset of the LEDs of said lighting unit are illuminating when the control signal is requesting that they not be illuminating.

7. The method of claim 1, wherein step (c) includes increasing, maintaining, reducing, terminating, or some combination thereof, the electrical power applied to said subset of the LEDs of said lighting unit.

8. The method of claim 1, wherein the LED display further comprises at least one cooling fan and said method further comprises:
(d) determining current drawn by said cooling fan;
(e) based on the current determined in step (d), determining that said cooling fan is experiencing a failure; and
(f) following step (e), terminating the supply of electrical power to said cooling fan.

9. The method of claim 8, wherein step (e) includes the fan either drawing current indicative of a locked rotor condition or the fan drawing no current.

10. The method of claim 1, wherein each lighting unit further includes a cooling fan.

11. A method of operating a LED display comprised of a cooling fan and a plurality of unitized lighting units tiled together, wherein each lighting unit includes an array of LEDs, said method comprising:
(a) determining via a computer network an electrical current drawn by said cooling fan;
(b) based on the electrical current determined in step (a), determining that said cooling fan is experiencing a failure; and
(c) following step (b), terminating via the computer network the supply of electrical power to said cooling fan.

12. The method of claim 11, wherein the failure in step (b) is the cooling fan drawing electrical current at a level indicative of either the cooling fan having a locked rotor and drawing electrical current in excess of electrical current drawn when the rotor is rotating, or the cooling fan being an open circuit and drawing no electrical current.

13. The method of claim 11, further including:
(d) determining via the computer network an electrical current drawn by each lighting unit in response to a control signal output for said lighting unit via the computer network;
(e) based on the electrical current determined in step (d), determining that at least one lighting unit is experiencing a failure; and
(f) determining a physical location of said lighting determined in step (e) via a network address of said lighting unit, by controlling illumination of a subset of the LEDs of said lighting unit, or both.

14. The method of claim 13, wherein each lighting unit further includes a lighting unit cooling fan.

15. The method of claim 13, wherein:
the control signal is a request for said subset of the LEDs of said lighting unit to illuminate; and
step (e) includes determining based on the electrical current drawn by said lighting unit being below a current level indicative of said subset of the LEDs of said lighting unit illuminating that at least a portion of said subset of the LEDs of said lighting unit are not illuminated.

16. The method of claim 13, wherein:
the control signal is a request for said subset of the LEDs of said lighting unit to not illuminate; and
step (e) includes determining based on the electrical current drawn by said lighting unit being above a current level indicative of said subset of the LEDs of said lighting unit not illuminating that at least a portion of said subset of the LEDs of said lighting unit are illuminated.

17. The method of claim 13, wherein step (f) includes controlling said subset of the LEDs of said lighting unit to display a color or pattern different than a subset of the LEDs of at least one other lighting unit that is not experiencing a failure or is experiencing a different type of failure.

18. The method of claim 13, wherein step (f) includes increasing, maintaining, reducing, terminating, or some combination thereof, the electrical power to said subset of the LEDs of said lighting unit.

19. A LED display comprising:
a plurality of unitized lighting units tiled together, wherein each lighting unit includes a plurality of LEDs, a lighting unit logic circuit operative for controlling the operation of the plurality of LEDs based on signals received by the lighting unit logic circuit, and a current sensing block operative for sensing electrical current supplied to the lighting unit logic circuit and the plurality of LEDs;
a lighting unit power supply operative for supplying the electrical current; and
a lighting unit controller operative for providing the signals to the lighting unit logic circuit, for acquiring an output of the current sensing block, and for outputting the acquired output of the current sensing block.

20. The LED display of claim 19, wherein the current sensing block includes:
a current transducer for sensing the current and for outputting an analog signal based on the sensed current; and
an analog-to-digital converter operative for converting the analog signal into a digital signal that is output by the current sensing block.

21. The LED display of claim 20, wherein the current transducer is either a hall effect sensor or a shunt resistor.

22. The LED display of claim 19, wherein the LED display is in communication with an operation terminal that is operative for causing the lighting unit controller to supply the signals to the lighting unit logic circuit, for causing the lighting unit controller to acquire the output of the current sensing block, and for processing the output of the current sensing block.

23. The method of claim 19, wherein each lighting unit further includes a fan, and the current sensing block is operative for sensing electrical current supplied to the combination of the fan, the lighting unit logic circuit and the plurality of LEDs.
